(19) United States
(12) Patent Application Publication
(10) Pub. No.: US 2020/0009783 A1
(43) Pub. Date: Jan. 9, 2020

(54) Heat Shrinkable Tube Assembly System

(71) Applicants: Tyco Electronics (Shanghai) Co. Ltd., Shanghai (CN); TE Connectivity Corporation, Berwyn, PA (US); Shenzhen AMI Technology Co., Ltd., Shezhen (CN); Measurement Specialties (Chengdu) Ltd., Chengdu (CN)

(72) Inventors: Fengchun Xie, Shanghai (CN); Dandan Zhang, Shanghai (CN); Roberto Francisco-Yi Lu, Bellevue, WA (US); Lvhai Hu, Shanghai (CN); Qinglong Zeng, Shanghai (CN); Lan Gong, Chengdu (CN); Qian Ying, Chengdu (CN)

(73) Assignees: Tyco Electronics (Shanghai) Co. Ltd., Shanghai (CN); TE Connectivity Corporation, Berwyn, PA (US); Shenzhen AMI Technology Co., Ltd., Shenzhen (CN); Measurement Specialities (Chengdu) Ltd., Chengdu (CN)

(21) Appl. No.: 16/578,960

(22) Filed: Sep. 23, 2019

Related U.S. Application Data
(63) Continuation of application No. PCT/EP2018/057332, filed on Mar. 22, 2018.

(30) Foreign Application Priority Data
Mar. 23, 2017 (CN) 201710178125.7

(51) Int. Cl. B29C 63/42; B25J 9/16; B29C 31/00

(52) U.S. Cl. CPC B29C 63/42; B29L 2031/3462; B29C 31/002; B25J 9/1697

(57) ABSTRACT

An assembly system includes a feeding mechanism adapted to feed a heat shrinkable tube, a cutting mechanism, a clamping mechanism, a robot, and a vision system. The cutting mechanism is adapted to cut off a section of heat shrinkable tube with a predetermined length from the heat shrinkable tube fed by the feeding mechanism. The clamping mechanism is adapted to clamp the heat shrinkable tube during cutting the heat shrinkable tube with the cutting mechanism. The robot is adapted to grip the section of heat shrinkable tube cut off from the heat shrinkable tube. The vision system is adapted to guide the robot to sleeve the section of heat shrinkable tube onto a wire of an electrical device.

### CROSS-REFERENCE TO RELATED APPLICATIONS

This application is a continuation of PCT International Application No. PCT/EP2018/057332, filed on Mar. 22, 2018, which claims priority under 35 U.S.C. § 119 to Chinese Patent Application No. 201710178125.7, filed on Mar. 23, 2017.

### FIELD OF THE INVENTION

The present invention relates to an assembly system and, more particularly, to an assembly system adapted to assemble a heat shrinkable tube on a wire of an electrical device.

### BACKGROUND

In electrical devices, for waterproofing and insulation, a heat shrinkable tube is often sleeved onto a wire of the electrical device. The heat shrinkable tube is generally manually assembled onto the wire of the electrical device. The process of manual assembly of the heat shrinkable tube is as follows: first, an operator needs to cut off a section of heat shrinkable tube with a predetermined length from a long heat shrinkable tube; then, the section of heat shrinkable tube is placed on a heating mechanism to heat one end thereof, so that the one end of the section of heat shrinkable tube is melted and sealed; then, the wire of the electrical device is inserted into the section of heat shrinkable tube through the opened other end of the section of heat shrinkable tube, so that the section of heat shrinkable tube is sleeved onto the wire; then, the section of heat shrinkable tube sleeved onto the wire is heated by a heater, so that the section of heat shrinkable tube is shrunk on the wire of the electrical device.

Manual assembly of the heat shrinkable tube onto the wire of the electrical device is very time-consuming, which reduces the manufacturing efficiency of the electrical device. In addition, the manual assembly reduces the accuracy of the assembly.

### SUMMARY

An assembly system includes a feeding mechanism adapted to feed a heat shrinkable tube, a cutting mechanism, a clamping mechanism, a robot, and a vision system. The cutting mechanism is adapted to cut off a section of heat shrinkable tube with a predetermined length from the heat shrinkable tube fed by the feeding mechanism. The clamping mechanism is adapted to clamp the heat shrinkable tube during cutting the heat shrinkable tube with the cutting mechanism. The robot is adapted to grip the section of heat shrinkable tube cut off from the heat shrinkable tube. The vision system is adapted to guide the robot to sleeve the section of heat shrinkable tube onto a wire of an electrical device.

### BRIEF DESCRIPTION OF THE DRAWINGS

The invention will now be described by way of example with reference to the accompanying Figures, of which:

FIG. 1 is a perspective view of an assembly system according to an embodiment;

FIG. 2 is a perspective view of a cutting mechanism of the assembly system;

FIG. 3 is a perspective view of a clamping mechanism of the assembly system;

FIG. 4 is a perspective view of a diameter adjusting needle of the clamping mechanism;

FIG. 5 is a perspective view of a robot of the assembly system; and

FIG. 6 is a sectional side view of a heat shrinkable tube sleeved onto a wire of an electrical device.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

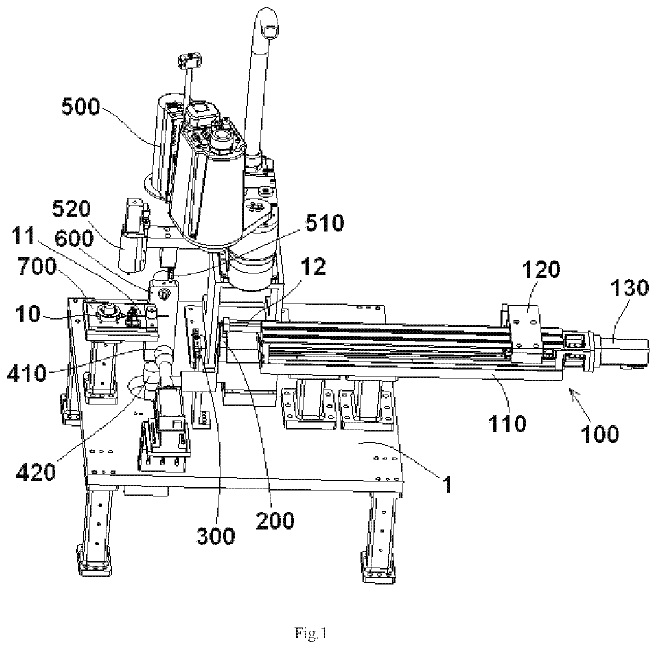

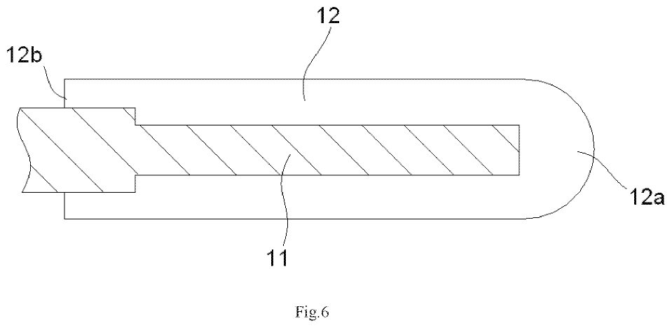

An assembly system according to an embodiment, as shown in FIG. 1, comprises a feeding mechanism 100, a cutting mechanism 200, a clamping mechanism 300, a vision system 410, 420, and a robot 500. The feeding mechanism 100 is adapted to feed a heat shrinkable tube 12. The cutting mechanism 200 is adapted to cut off a section of heat shrinkable tube 12 with a predetermined length from the heat shrinkable tube 12 fed by the feeding mechanism 100. The clamping mechanism 300 is adapted to clamp the heat shrinkable tube 12 during cutting the heat shrinkable tube 12 with the cutting mechanism 200. The robot 500 is adapted to grip the section of heat shrinkable tube 12 cut off from the heat shrinkable tube 12. The vision system 410, 420 is adapted to guide the robot 500 to sleeve the section of heat shrinkable tube 12 onto a wire 11 of an electrical device 10, as shown in FIG. 6. In an embodiment, the electrical device 10 may be a sensor or a connector.

The assembly system, as shown in FIG. 1, comprises a heating mechanism 600 configured to heat a first end 12a, a right end in FIG. 6, of the section of heat shrinkable tube 12 before the section of heat shrinkable tube 12 is sleeved onto the wire 11 of the electrical device 10, so that the first end 12a is melted and sealed. The wire 11 is inserted into the section of heat shrinkable tube 12 through an opened second end 12b, a left end in FIG. 6, of the section of heat shrinkable tube 12. In an embodiment, the heating mechanism 600 is adapted to spray a hot air to heat the first end 12a of the section of heat shrinkable tube 12, so that the first end 12a of the section of heat shrinkable tube 12 is melted and sealed.

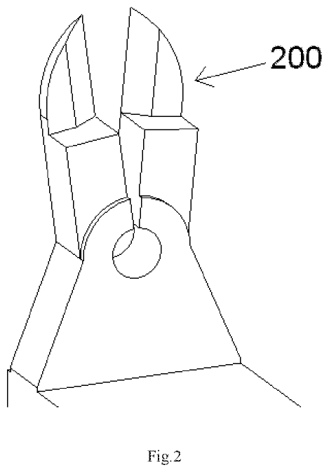

The cutting mechanism 200, as shown in FIG. 2, may include a scissors and a driver for driving the scissors to open and close.

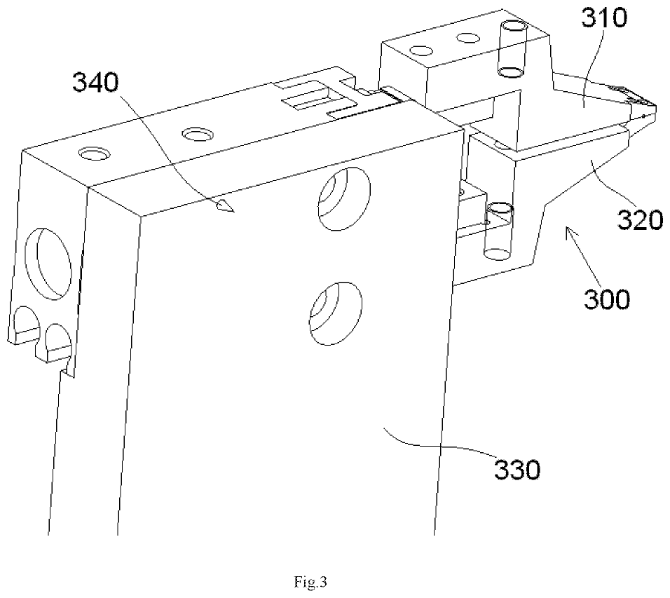

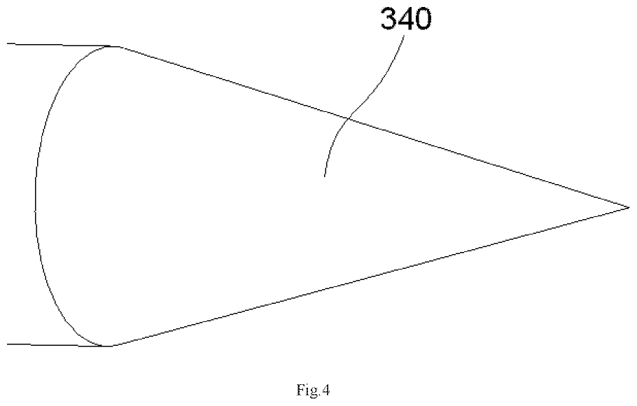

The clamping mechanism 300, as shown in FIGS. 3 and 4, includes a pair of clamping fingers 310, 320. In the shown embodiment, one of the pair of clamping fingers 310, 320 is movable and the other of the pair of clamping fingers 310, 320 is fixed. The clamping mechanism 300 has a diameter adjusting needle 340 disposed on a support body 330 of the clamping mechanism 300 with an axis of the diameter adjusting needle 340 extending in a horizontal direction. In the shown embodiment, the diameter adjusting needle 340 is formed in a cone shape.

The diameter adjusting needle 340 is adapted to expand a diameter of the section of heat shrinkable tube 12 to a predetermined size before the section of heat shrinkable tube 12 is sleeved onto the wire 11 of the electrical device 10. In this way, after being expanded, the expanded heat shrinkable tube 12 may be smoothly sleeved onto the wire 11 of the electrical device 10. The robot 500 is adapted to sleeve the section of heat shrinkable tube 12 onto the diameter adjusting needle 340 under the guidance of the vision system 410, 420, so as to expand the diameter of the section of heat shrinkable tube 12 to the predetermined size with the diameter adjusting needle 340.

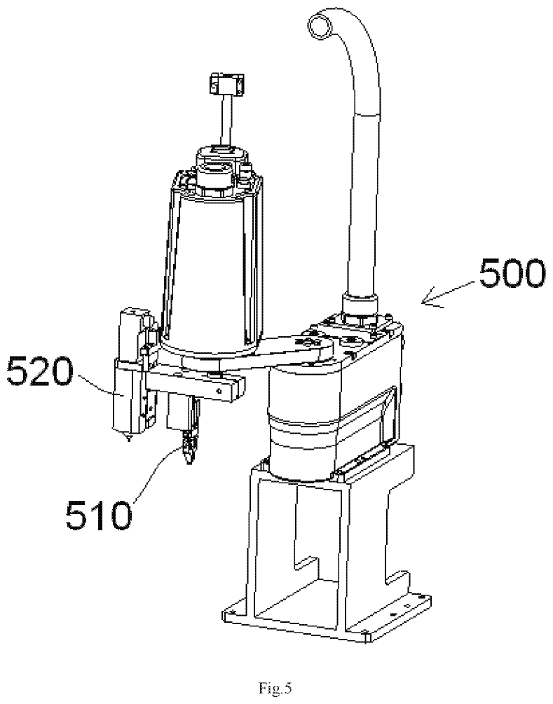

The assembly system, as shown in FIGS. 1 and 5, further comprises a heater 520 adapted to heat the section of heat shrinkable tube 12 after the section of heat shrinkable tube 12 is sleeved onto the wire 11 of the electrical device 10, so that the section of heat shrinkable tube 12 is heated and shrunk on the wire 11. In the shown embodiment, the heater 520 is mounted on the robot 500, and the robot 500 is adapted to move the heater 520 to the section of heat shrinkable tube 12 sleeved on the wire 11 under the guidance of the vision system 410, 420, so that the section of heat shrinkable tube 12 is evenly heated and shrunk on the wire 11. In an embodiment, the heater 520 is a soldering head adapted to perform a welding operation; in this way, the assembly system does not need an additional heater for the heat shrinkable tube 12.

In the embodiment shown in FIGS. 1 and 5, a gripper 510 is mounted on the robot 500, and the robot 500 is adapted to grip the section of heat shrinkable tube 12 with the gripper 510. In an embodiment, the robot 500 may be a multi-degree of freedom robot, for example, a six-axis robot.

The assembly system, as shown in FIG. 1, comprises a fixing device 700 adapted to fix the electrical device 10 and the wire 11 of the electrical device 10 in position.

The vision system 410, 420, as shown in FIG. 1, includes a first camera 410 and a second camera 420. An optical axis of the first camera 410 extends in a horizontal direction perpendicular to the wire 11, and an optical axis of the second camera 420 extends in a vertical direction perpendicular to the wire 11. In this way, a horizontal position and a vertical position of the section of the heat shrinkable tube 12 may be obtained by the robot 500, which ensures that the section of the heat shrinkable tube 12 is capable of being accurately sleeved onto the wire 11 of the electrical device 10.

The feeding mechanism 100, as shown in FIG. 1, includes a main body 110, a sliding block 120, and a linear actuator 130. A slot extending in a longitudinal direction of the main body 110 and configured to receive the heat shrinkable tube 12 is formed on the main body 110. The sliding block 120 is slidably mounted on the main body 110 and adapted to push the heat shrinkable tube 12 outward in the longitudinal direction of the main body 110, so that the heat shrinkable tube 12 is moved outward in the longitudinal direction of the main body 110. The linear actuator 130 is mounted on the main body 110 and adapted to drive the sliding block 120 to slide in the longitudinal direction of the main body 110.

The assembly system, as shown in FIG. 1, comprises a base 1. The feeding mechanism 100, the cutting mechanism 200, the clamping mechanism 300, the vision system 410, 420, the robot 500, the heating mechanism 600, and the fixing device 700 are mounted on the base 1.

A process of assembling the heat shrinkable tube 12 onto the wire 11 of the electrical device 10 will now be described in greater detail with reference to FIGS. 1-6.

First, as shown in FIG. 1, the feeding mechanism 100 feeds the heat shrinkable tube 12 to the cutting mechanism 200 and the clamping mechanism 300.

Then, the clamping mechanism 300 clamps the heat shrinkable tube 12, and the cutting mechanism 200 cuts off a section of heat shrinkable tube 12 with a predetermined length from the heat shrinkable tube 12.

Then, the clamping mechanism 300 releases the heat shrinkable tube 12, and the robot 500 grips the section of heat shrinkable tube 12 cut off from the heat shrinkable tube 12.

Then, the robot 500 sleeves the section of heat shrinkable tube 12 onto the diameter adjusting needle 340 under the guidance of the vision system 410, 420, so as to expand the diameter of the section of heat shrinkable tube 12 to the predetermined size by the diameter adjusting needle 340.

Then, the robot 500 moves the section of heat shrinkable tube 12 to the heating mechanism 600 under the guidance of the vision system 410, 420, and the heating mechanism 600 heats the first end 12a of the section of heat shrinkable tube 12, so that the first end 12a of the section of heat shrinkable tube 12 is melted and sealed.

Then, the robot 500 sleeves the section of heat shrinkable tube 12 onto the wire 11 of the electrical device 10 under the guidance of the vision system 410, 420.

Then, the robot 500 releases the section of heat shrinkable tube 12 and moves the heater 520 to the section of heat shrinkable tube 12 sleeved onto the wire 11. The heater 520 evenly heats the section of heat shrinkable tube 12, so that the section of heat shrinkable tube 12 is heated and shrunk on the wire 11. The heat shrinkable tube 12 is assembled onto the wire 11 of the electrical device 10. The assembly system disclosed herein realizes the automatic assembly of the heat shrinkable tube 12, improving the assembly efficiency and ensuring the assembly accuracy.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. An assembly system, comprising:
a feeding mechanism adapted to feed a heat shrinkable tube;
a cutting mechanism adapted to cut off a section of heat shrinkable tube with a predetermined length from the heat shrinkable tube fed by the feeding mechanism;
a clamping mechanism adapted to clamp the heat shrinkable tube during cutting the heat shrinkable tube with the cutting mechanism;
a robot adapted to grip the section of heat shrinkable tube cut off from the heat shrinkable tube; and
a vision system adapted to guide the robot to sleeve the section of heat shrinkable tube onto a wire of an electrical device.

2. The assembly system of claim 1, further comprising a heating mechanism configured to heat a first end of the section of heat shrinkable tube, melting and sealing the first end of the section of heat shrinkable tube before the section of heat shrinkable tube is sleeved onto the wire.

3. The assembly system of claim 2, wherein the wire is inserted into the section of heat shrinkable tube through an opened second end of the section of heat shrinkable tube.

4. The assembly system of claim 3, wherein the heating mechanism is adapted to apply a hot air on the first end of the section of heat shrinkable tube to melt and seal the first end.

5. The assembly system of claim 3, further comprising a diameter adjusting needle adapted to expand a diameter of the section of heat shrinkable tube to a predetermined size before the section of heat shrinkable tube is sleeved onto the wire of the electrical device.

6. The assembly system of claim 5, wherein the diameter adjusting needle is formed in a cone shape.

7. The assembly system of claim 5, wherein the robot is adapted to sleeve the section of heat shrinkable tube onto the diameter adjusting needle under the guidance of the vision system.

8. The assembly system of claim 5, wherein the diameter adjusting needle is disposed on a support body of the clamping mechanism, an axis of the diameter adjusting needle extending in a horizontal direction.

9. The assembly system of claim 1, further comprising a heater adapted to heat the section of heat shrinkable tube after the section of heat shrinkable tube is sleeved onto the wire, shrinking the section of heat shrinkable tube on the wire.

10. The assembly system of claim 9, wherein the heater is mounted on the robot.

11. The assembly system of claim 10, wherein the robot is adapted to move the heater to the section of heat shrinkable tube sleeved on the wire under the guidance of the vision system.

12. The assembly system of claim 9, wherein the heater has a soldering head adapted to perform a welding operation.

13. The assembly system of claim 1, wherein a gripper is mounted on the robot and the robot is adapted to grip the section of heat shrinkable tube with the gripper.

14. The assembly system of claim 1, further comprising a fixing device adapted to fix the electrical device and the wire of the electrical device in a position.

15. The assembly system of claim 1, wherein the vision system includes a first camera and a second camera.

16. The assembly system of claim 15, wherein an optical axis of the first camera extends in a horizontal direction perpendicular to the wire and an optical axis of the second camera extends in a vertical direction perpendicular to the wire.

17. The assembly system of claim 1, wherein the feeding mechanism includes:
a main body on which a slot extending in a longitudinal direction of the main body and configured to receive the heat shrinkable tube is formed;
a sliding block slidably mounted on the main body and adapted to push the heat shrinkable tube outward in the longitudinal direction of the main body; and
a linear actuator mounted on the main body and adapted to drive the sliding block to slide in the longitudinal direction of the main body.

18. The assembly system of claim 1, wherein the clamping mechanism has a pair of clamping fingers, one of the pair of clamping fingers is movable and the other of the pair of clamping fingers is fixed.
